(19) United States
(12) Patent Application Publication
(10) Pub. No.: US 2026/0093633 A1
(43) Pub. Date: Apr. 2, 2026

(54) TECHNIQUES FOR INVALIDATING CACHED CONTENT MANAGED BY CONTENT DELIVERY NETWORKS

(71) Applicant: NETFLIX, INC., Los Gatos, CA (US)

(72) Inventors: Christopher Alan NEWTON, North Richland Hills, TX (US); Ivan P. IVANOV, Bothell, WA (US); Xiaomei LIU, Cupertino, CA (US)

(21) Appl. No.: 18/981,306

(22) Filed: Dec. 13, 2024

Related U.S. Application Data
(60) Provisional application No. 63/702,076, filed on Oct. 1, 2024.

(51) Int. Cl. G06F 12/0891

(52) U.S. Cl. CPC G06F 12/0891

(57) ABSTRACT

In various embodiments, a technique for invalidating cached content stored within a content delivery network includes receiving an invalidation instruction from a control server, where the invalidation instruction includes at least one attribute, receiving a first request for a first object stored in the content delivery network, where the first object is associated with a first set of attributes, determining that the first set of attributes includes the at least one attribute, and removing the first object from the content delivery network.

### CROSS-REFERENCE TO RELATED APPLICATIONS

This application claims the benefit of U.S. Provisional Application titled “TECHNIQUES FOR INVALIDATING CACHED CONTENT MANAGED BY CONTENT DELIVERY NETWORKS,” filed on Oct. 1, 2024, and having Ser. No. 63/702,076. The subject matter of this related application is hereby incorporated herein by reference.

### BACKGROUND

### Field of the Various Embodiments

Embodiments of the present disclosure relate generally to computer science and video processing and, more specifically, to techniques for invalidating cached content managed by content delivery networks.

### Description of the Related Art

Modern streaming services oftentimes implement cloud-based networks of computer systems to stream audiovisual content associated with various media titles to endpoint devices. A given cloud-based network typically includes one or more content servers, one or more encoding pipelines, one or more origin servers, and a content delivery network (CDN). In such an architecture, the content servers are storage and distribution mechanisms that store raw audiovisual content and distribute that content to the encoding pipelines. The encoding pipelines encode the raw audiovisual content into a compressed form and transmit encoded audiovisual content to the origin servers. The origin servers store the encoded audiovisual content and distribute that content to the CDN. The CDN typically includes a hierarchy of nodes that are geographically distributed across a large region and configured to store the encoded audiovisual content. During playback, a given endpoint device can request specific portions of the encoded audiovisual content associated with a given media title, and a geographically proximate node within the CDN can then transmit the requested portions of encoded audiovisual content to the endpoint device with relatively low latency. The endpoint device then decodes the encoded audiovisual content and outputs the decoded audiovisual content for display to a user.

Conventional streaming services often implement multiple redundant encoding pipelines and multiple redundant origin servers in order to compensate for various network conditions that can adversely affect the distribution of audiovisual content to the different endpoint devices. For example, a conventional streaming service could include two encoding pipelines that generate redundant versions of encoded audiovisual content. If a network outage disables one of those encoding pipelines, then the other encoding pipeline can continue generating encoded audiovisual content for the streaming service. Similarly, a conventional streaming service could implement two origin servers that store redundant versions of the encoded audiovisual content. If a network outage disables one of those origin servers, then the other origin server can continue storing the encoded audiovisual content and distributing that content into the CDN. Typically, when a network outage occurs, any endpoint device receiving encoded audiovisual content derived from an impacted encoding pipeline or origin server begins receiving encoded audiovisual content derived from an encoding pipeline or origin server not impacted by the network outage instead. These types of changes usually occur transparently to the user because sequential portions of audiovisual content are normally indexed in a manner that enables an endpoint device to output sequential portions of the audiovisual content according to an intended order, regardless of the source of the audiovisual content.

Under certain circumstances, specific portions of encoded audiovisual content stored in a CDN can become flawed and potentially unusable. When a portion of encoded audiovisual content becomes flawed, that portion of encoded audiovisual content should no longer be transmitted to any endpoint devices for playback. For example, an encoding pipeline could inadvertently generate portions of encoded audiovisual content that include pixelated frames of video content. Given that pixelated frames of video content are oftentimes visually disruptive to users, such frames should not be transmitted to any endpoint devices for playback. Similarly, redundant encoding pipelines could inadvertently generate portions of encoded audiovisual content that are indexed incorrectly and cannot be output sequentially by an endpoint device according to an intended order. This particular issue can arise when an endpoint device switches from outputting audiovisual content derived from one encoding pipeline or origin server to outputting audiovisual content derived from another encoding pipeline or origin server instead. In these types of situations, the incorrect indexing of the audiovisual content can cause an endpoint device to either output a portion of audiovisual content that has already been viewed by a user (which can appear to the user as a freeze or a lag), or output a portion of audiovisual content for display to a user that should not yet be output (which can appear to the user as a discontinuous jump forward in the audiovisual content).

When a given portion of encoded audiovisual content is determined to be flawed for any reason, an invalidation instruction that identifies the uniform resource locator (URL) of the invalid portion of encoded audiovisual content is typically issued to the CDN. Each node within the CDN then determines whether any stored portions of encoded audiovisual content have a URL that matches the URL identified in the invalidation instruction. If a given node finds a match, then the node removes the portion of encoded audiovisual content associated with the matching URL. Nodes that remove invalid portions of encoded audiovisual content in this manner can subsequently request, as replacements, alternate versions of those portions of encoded audiovisual content from upstream nodes and/or upstream origin servers. This process can be repeated in order to invalidate and replace multiple flawed portions of encoded audiovisual content associated with a given media title.

Alternatively, in some CDN configurations, invalidation instructions can target multiple invalid portions of encoded audiovisual content using a URL that includes a specific prefix followed by a wildcard character, which is a special character that matches any sequence of characters. Accordingly, a URL that includes a given URL prefix followed by a wildcard character ends up matching any URL that includes the URL prefix, regardless of what character(s) follow the prefix. As a general matter, wildcard characters allow a single URL pattern to match a multitude of different URLs. Thus, an invalidation instruction that implements a wildcard character can be used to invalidate and replace many different portions of encoded audiovisual content, where the different portions of audiovisual content are associated with similar URLs.

One drawback of the invalidation techniques described above is that invalidating and replacing many different portions of encoded audiovisual content associated with a given media title can require significant processing time and resources. In this regard, a typical CDN can include a vast number of nodes that are distributed across a large geographic region or even the entire world. Every node within the CDN stores a vast number of different portions of encoded audiovisual content associated with a large number of different media titles. Identifying and then replacing many different portions of encoded audiovisual content can therefore be extremely resource intensive and costly. Further, the resource requirements of these operations are increased when an invalidation instruction includes wildcard characters, because the URL comparison operations implemented for wildcard characters typically require vastly more comparisons and usually involve complex pattern-matching algorithms. Consequently, implementing wildcard characters increases the computational complexity of an already resource-intensive and expensive process.

Another drawback of the invalidation techniques described above is that processing a given invalidation instruction can take quite a bit of time, given the complexity and resource-intensive nature of the URL-based comparison operations. Such latencies are especially problematic when a streaming service streams live events, such as sporting events or other events that occur in real-time. When streaming a live event, invalidation instructions need to be handled as expeditiously as possible in order to avoid outputting invalid audiovisual content, such as pixelated frames of video content or out-of-sequence portions of audiovisual content. However, conventional invalidation techniques usually cannot be implemented fast enough during live events to avoid these types of issues.

As the foregoing illustrates, what is needed in the art is a more effective technique for handling invalidation instructions in CDNs.

### SUMMARY

In various embodiments, a technique for invalidating cached content stored within a content delivery network (CDN) includes receiving an invalidation instruction from a control server, where the invalidation instruction includes at least one attribute, receiving a first request for a first object stored in the content delivery network, where the first object is associated with a first set of attributes, determining that the first set of attributes includes the at least one attribute, and removing the first object from the content delivery network.

At least one technical advantage of the disclosed techniques relative to the prior art is that the disclosed techniques enable a CDN to passively invalidate many objects stored in the CDN without having to immediately refresh or reload those objects. Accordingly, with the disclosed techniques, objects can be invalidated using substantially fewer computational resources and incurring significantly less computational cost compared to prior art techniques. Another technical advantage of the disclosed techniques is that, because the URLs associated with every object stored in the CDN do not need to be analyzed when invalidating an object, objects can be invalidated substantially faster compared to prior art techniques. Accordingly, the disclosed techniques are particularly compatible with live streaming implementations, given that live streaming requires valid portions of audiovisual content to be delivered to endpoint devices in a time-sensitive manner. Further, invalidations can be performed using any set of attributes related to cached objects, providing added flexibility compared to conventional approaches that operate on a URL basis. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments; and

FIG. 4 is a more detailed block diagram of the endpoint device of FIG. 1, according to various embodiments;

FIG. 5A illustrates a network infrastructure that can be used to distribute segments of audiovisual content to the endpoint devices of FIG. 1 via a content delivery network (CDN), according to various embodiments;

FIG. 5B illustrates an exemplary sequence of objects corresponding to one or more segments of audiovisual content that are distributed by the network infrastructure of FIG. 5A, according to various embodiments;

FIG. 6 illustrates how a node included in the CDN of FIG. 5A invalidates cached objects corresponding to one or more segments of audiovisual content, according to various embodiments; and

FIG. 7 is a flow diagram of method steps for invalidating objects corresponding to one or more segments of audiovisual content currently being streamed to an endpoint device, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

Modern streaming services oftentimes implement cloud-based networks of computer systems to stream audiovisual content associated with various media titles to endpoint devices. A given cloud-based network typically includes one or more content servers, one or more encoding pipelines, one or more origin servers, and a content delivery network (CDN). Conventional streaming services often implement multiple redundant encoding pipelines and multiple redundant origin servers in order to compensate for various network conditions that can adversely affect the distribution of audiovisual content to endpoint devices. For example, and without limitation, if a network outage disables one encoding pipeline, then a remaining encoding pipeline could continue to encode audiovisual content for distribution to the CDN.

Under certain circumstances, specific portions of encoded audiovisual content stored in the CDN can become flawed and should no longer be transmitted to endpoint devices. When a given portion of encoded audiovisual content is determined to be flawed for any reason, an invalidation instruction is issued to the CDN indicating the URL of the flawed portion of encoded audiovisual content. Each node within the CDN then determines whether any stored portions of encoded audiovisual content have a URL that matches the URL indicated in the invalidation instruction. If a given node finds a match, the node removes and replaces the portion of encoded audiovisual content with the matching URL. In some CDN configurations, invalidation instructions can target multiple invalid portions of encoded audiovisual content using a URL that includes a wildcard character. An invalidation instruction that implements a wildcard character can be used to invalidate many different portions of encoded audiovisual content.

One drawback associated with the conventional invalidation techniques described above is that identifying many flawed portions of audiovisual content and then obtaining valid versions of that audiovisual content can be extremely resource intensive and therefore very costly. This issue is magnified when invalidation instructions include wildcard characters, because every URL must be analyzed using complex pattern-matching algorithms. Another drawback associated with the conventional invalidation techniques described above is that given the resource-intensive nature of these techniques, as described, processing a given invalidation instruction can sometimes occur very slowly. This issue is especially problematic when a streaming service streams live events, such as sporting events or other events that occur in real time. Further, in some configurations, the same URL can refer to several different versions of a given object, including both flawed versions of the object and valid versions of the object. Consequently, an invalidation instruction can sometimes cause valid versions of a given object to be discarded, thereby needlessly wasting processing resources and network bandwidth.

To address the issues described above, various embodiments include a CDN that includes a network of nodes configured to store objects representing segments of audiovisual content. Endpoint devices coupled to the CDN are configured to stream audiovisual content to users by requesting objects that represent sequential segments of audiovisual content associated with various media titles. Each node included in the CDN includes a request handler that services requests received from endpoint devices. In response to receiving a given request for a specific object, the request handler first accesses metadata associated with the object. The metadata indicates, among other things, various attributes associated with the object, including an encoder used to encode the object, an origin server that distributes the object, a region where the origin server resides, a status code associated with the object, a time when the object was created and/or modified, and/or a segment index that reflects a desired ordering with which the audiovisual content associated with the object should be output by an endpoint device. The request handler then accesses a set of invalidation instructions that describe objects which should be invalidated by the node. A given invalidation instruction indicates at least one of the various attributes that can be associated with any given object. The request handler determines, based on the metadata associated with the requested object and based on the set of invalidation instructions, whether any of the invalidation instructions indicate any of the attributes associated with the requested object. If any of the invalidation instructions indicates one or more attributes associated with the object, then the request handler invalidates the object. In doing so, the request handler can mark the object as invalid and/or discard the object entirely. The node can then request an alternate version of the object from another node included in the CDN in order to fulfill the request. If none of the invalidation instructions indicates one or more attributes associated with the object, then the request handler simply fulfills the request using the object.

At least one technical advantage of the disclosed techniques relative to the prior art is that the disclosed techniques enable a CDN to passively invalidate many objects stored in the CDN without having to immediately refresh or reload those objects. Accordingly, with the disclosed techniques, objects can be invalidated using substantially fewer computational resources and incurring significantly less computational cost compared to prior art techniques. Another technical advantage of the disclosed techniques is that, because the URLs associated with every object stored in the CDN do not need to be analyzed when invalidating an object, objects can be invalidated substantially faster compared to prior art techniques. Accordingly, the disclosed techniques are particularly compatible with live streaming implementations, given that live streaming requires valid portions of audiovisual content to be delivered to endpoint devices in a time-sensitive manner. These technical advantages provide one or more technological advancements over prior art approaches.

### System Overview

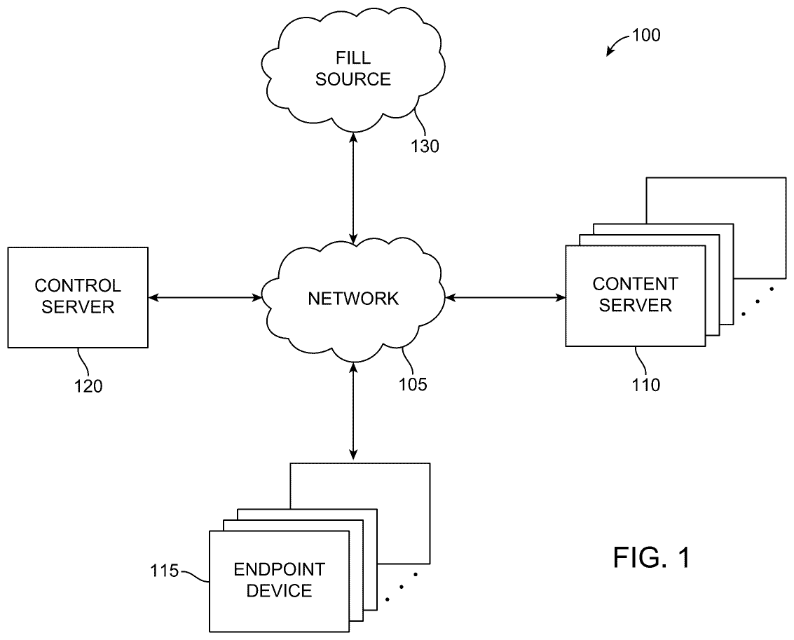

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

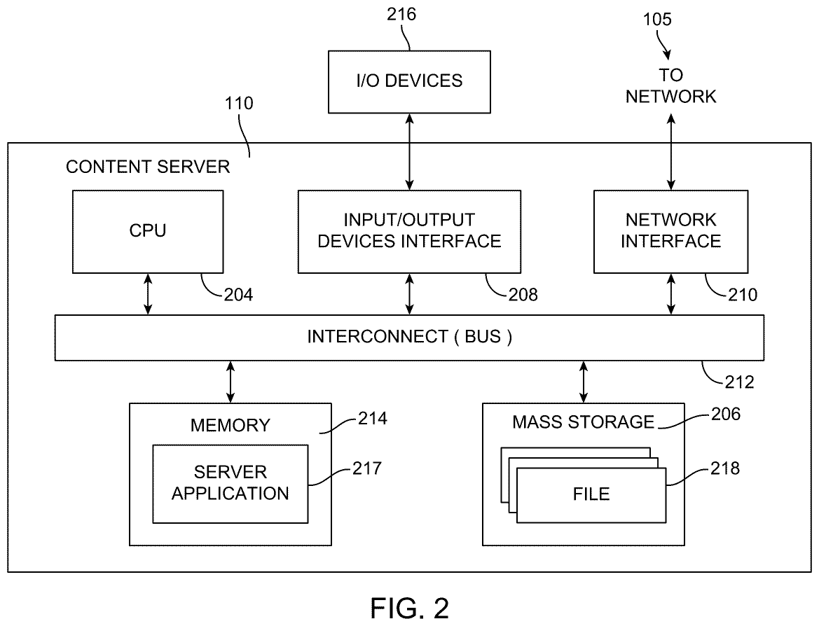

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a mass storage 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the mass storage 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The mass storage 206 may include one or more hard disk drives, solid state storage devices, or similar storage devices. The mass storage 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the mass storage 206 and transmits the file 218 to an endpoint device 115 or a content server 110 via the network 105.

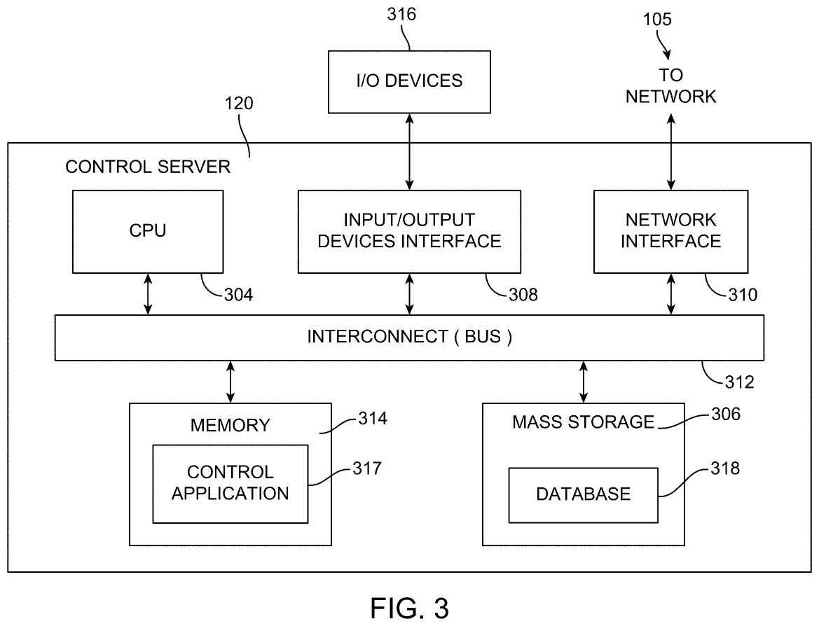

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a mass storage 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the mass storage 306. The interconnect 312 is configured to facilitate transmission of data between the CPU 304, the mass storage 306, I/O devices interface 308, the network interface 310, and the system memory 314. The I/O devices interface 308 is configured to transmit input data and output data between the I/O devices 316 and the CPU 304 via the interconnect 312. The mass storage 306 may include one or more hard disk drives, solid state storage devices, and the like. The mass storage 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

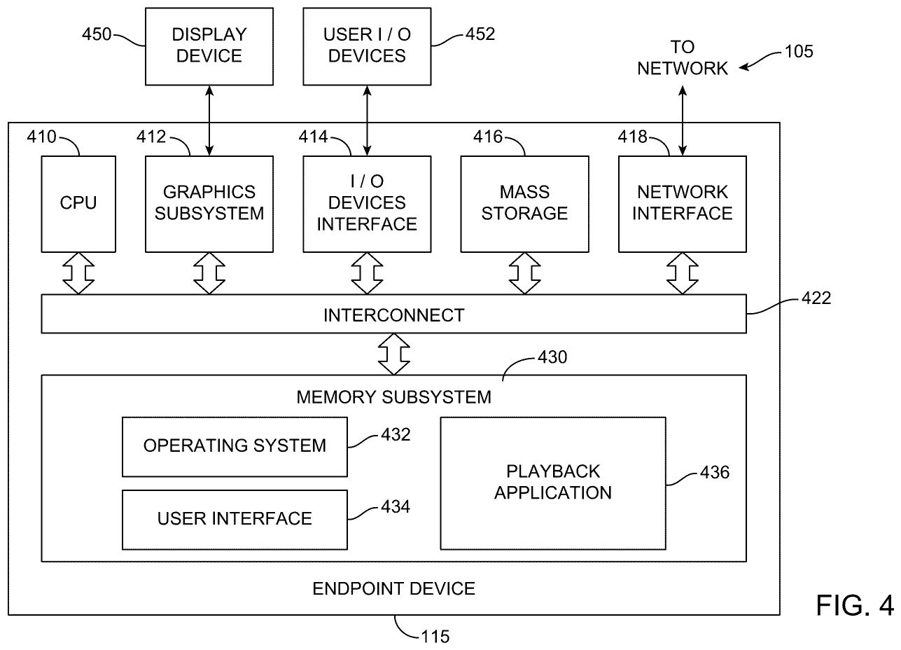

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Invalidating Cached Content Managed by Content Delivery Networks

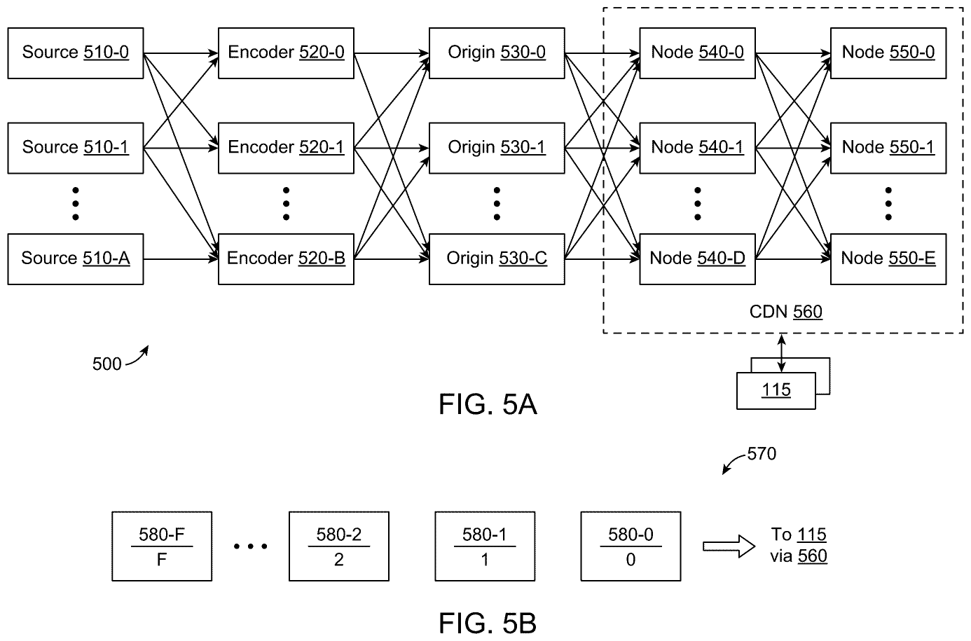

FIG. 5A illustrates a network infrastructure 500 that distributes segments of audiovisual content to endpoint devices 115 via a content delivery network (CDN), according to various embodiments. As shown, the network infrastructure 500 includes sources 510-0 through 510-A, encoders 520-0 through 520-B, origins 530-0 through 530-C, nodes 540-0 through 540-D, and nodes 550-0 through 550-E. The values of A, B, C, D, and E may vary across different embodiments, although the values of A, B, C, D, and E are generally integers. Accordingly, the network infrastructure 500 may include any technically feasible number of sources 510, encoders 520, origins 530, nodes 540, and nodes 550.

Various components of the network infrastructure 500 can be implemented via components of the network infrastructure 100 described above in conjunction with FIGS. 1-4. In particular, in various embodiments, source(s) 510 may be implemented via one or more fill sources 130, encoder(s) 520 may be implemented via one or more control servers 120, and/or any of node(s) 540 and/or node(s) 550 may be implemented via one or more content servers 110. As a general matter, the network infrastructure 500 may be implemented by, or included within, the network infrastructure 100 of FIG. 1, according to various embodiments.

In addition, various components of the network infrastructure 100 and/or network infrastructure 500 may form a portion of a control plane, such as the control server 120, for example and without limitation, while other components of the network infrastructure 100 or network infrastructure 500 may form a portion of a data plane, such as the origin(s) 530, for example and without limitation. In one embodiment, the control server 120 may configure the origin(s) 530, the node(s) 540, and/or the node(s) 550 to store, distribute, and/or invalidate objects representing audiovisual content based on invalidation instructions, as described in greater detail below.

In operation, the sources 510 store raw frames of audiovisual content corresponding to a library of different media titles. Those media titles can be previously recorded, or, in some cases, correspond to live events that are occurring in real time. The sources 510 distribute the raw frames of audiovisual content to the encoders 520. A given encoder 520, upon receipt of raw frames of audiovisual content, encodes the raw frames of audiovisual content into a compressed object. Each source 510 can distribute raw frames of audiovisual content to any encoder 520, and in some instances multiple sources 510 may distribute the same raw frames of audiovisual content to multiple different encoders 520, which, in turn, generate redundant versions of compressed objects. The encoders 520 transmit the compressed objects to the origins 530. Multiple different encoders 520 can transmit redundant versions of compressed objects to multiple different origins 530. In various embodiments, the origins 530 may reside in different logical or geographical regions of an underlying cloud infrastructure. The origins 530 distribute the compressed objects to the CDN 560. In one embodiment, a given origin 530 may invalidate a compressed object based on an invalidation instruction received from the control server 120.

The CDN includes a hierarchy of nodes 540 and 550. Although the CDN 560 shown includes two layers of nodes, persons skilled in the art will understand that CDN 560 can be implemented via any technically feasible network architecture. In the exemplary CDN shown, without limitation, nodes 540 could be parent nodes, while nodes 550 could be child nodes. Nodes 540 and 550 operate as caches to store compressed objects corresponding to segments of audiovisual content associated with media titles. Each node 540 or 550 is configured to respond to requests from endpoint devices 115 for specific objects corresponding to one or more segments of audiovisual content. In doing so, a given node 550 may determine that a requested object is unavailable, and may then request the object from an adjacent node 550 or an upstream node 540 in order to fulfill the request from the endpoint device 115.

When streaming a given media title, a given endpoint device 115 makes requests for objects in the manner described according to a particular sequence associated with the media title. As a general matter, each media title indicates a specific sequence of objects corresponding to a specific sequence of segments. Moreover, the specific sequence of segments generally corresponds to a specific sequence of frames of audiovisual content. In many cases, a given media title can be represented by multiple versions of a particular sequence of segments, where each version could have slightly different characteristics, such as slightly different resolutions, for example and without limitation.

FIG. 5B illustrates an exemplary sequence of objects corresponding to one or more segments of audiovisual content that are distributed by the network infrastructure of FIG. 5A, according to various embodiments. As shown, a sequence 580 includes objects 580-0 through 580-F, where F is an integer value. Each object 580 corresponds to at least one segment associated with a given media title, and therefore includes one or more frames of audiovisual content in compressed form. Each object 580-0 through 580-F also includes a segment index 0 through F, respectively, indicating an order in which objects 580 should be decoded and the resultant frames of audiovisual content output via an endpoint device 115.

Referring generally to FIGS. 5A-5B, a given object 580 can be derived from any given source 510, encoded by any given encoder 520, stored and distributed by any given origin 530, and cached by any node 540 and/or 550 within CDN 560. Accordingly, during streaming of a given media title, a given endpoint device 115 can request and receive objects 580 that have traversed the network infrastructure 500 via a variety of different paths.

Under certain circumstances, some objects 580 may be determined to be flawed and may therefore need to be masked by the origin(s) 530 and excluded from further distribution and/or discarded by the CDN 560. For example, and without limitation, one or more encoders 520 could inadvertently introduce encoding artifacts into one or more frames of audiovisual content associated with an object. Alternatively, for example and without limitation, one or more encoders 520 could inadvertently generate objects having incorrect segment indices, thereby preventing frames of audiovisual content associated with those objects from being output according to an intended order. Persons skilled in the art will understand that cached objects can become flawed for a variety of possible reasons.

In these situations, the control server 120 or any other technically feasible component of network infrastructure 100 issues an invalidation instruction to the origin(s) 530 and/or the CDN 560 indicating specific attributes of the one or more objects 580 that have been determined to be flawed. Based on the invalidation instruction, the origin(s) 530 can identify the one or more objects 580 having those specific attributes, and can then mark the one or more objects 580 as invalid and exclude those objects from further distribution to the CDN 560.

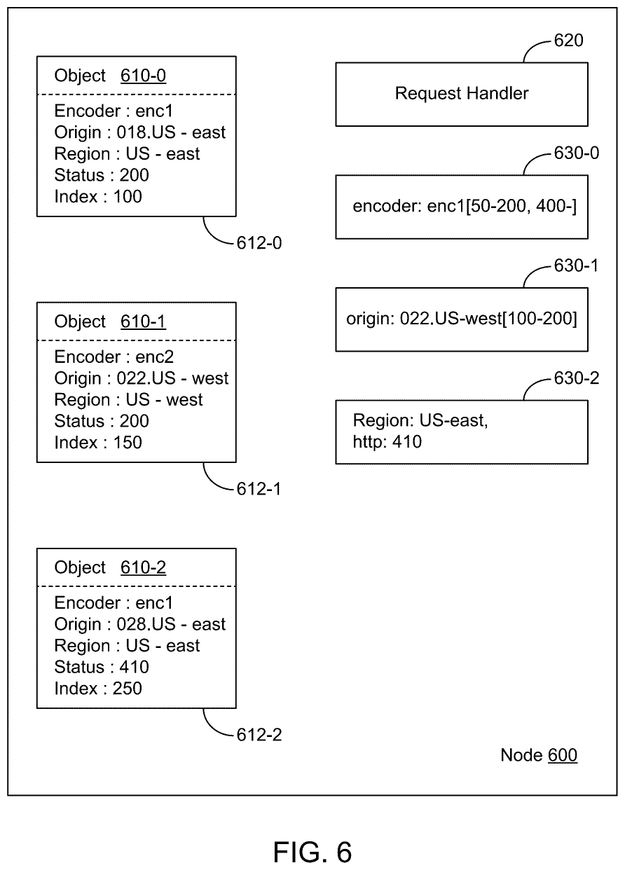

In addition, in response to receiving the invalidation instruction, the CDN 560 distributes the invalidation instruction to the nodes 540 and 550. Each node 540 and 550 includes a request handler that fulfills requests received from endpoint devices 115 for specific objects. When such a request is received, the request handler analyzes any previously received invalidation instruction to determine whether the requested object is potentially flawed and should be considered invalid. If a requested object is not flawed, the request handler fulfills the request. However, if a requested object is, in fact, flawed, as indicated by the invalidation instruction, then the request handler can mark the object as being invalid, discard the object, and request an alternate, valid version of the object from another node 540 or 550 or from one of the origins 530. In this manner, each node of CDN 560 is configured to invalidate objects that are determined to be flawed at or after the time when those objects are requested. In various embodiments, each origin 530 may include a request handler that performs similar operations as those described above in order to exclude flawed objects from distribution to the CDN 560. With this approach, a given object 580 can traverse the network infrastructure 500 from the source 510 to the endpoint device 115, or be invalidated during that traversal, when the invalidation instructions processed by the origins 530 and the CDN 560 are similar or the same. FIG. 6 sets forth several examples of how the request handler within an origin 530 and/or a node within the CDN 560 processes invalidation instructions.

FIG. 6 illustrates how a node included in the CDN of FIG. 5A invalidates cached objects corresponding to one or more segments of audiovisual content, according to various embodiments. As shown, an exemplary node 600 includes exemplary objects 610-0, 610-1, and 610-2, a request handler 620, and exemplary invalidation instructions 630-0, 630-1, and 630-2. Each object 610 is associated with exemplary metadata 612. In various embodiments, a given object 610 can include corresponding metadata 612, or the metadata associated with a given object 610 can be stored separately. In one embodiment, metadata 612 can be implemented via a hypertext transfer protocol (HTTP) header that is accessed separately from the corresponding object 610 via an HTTP HEAD request. As a general matter, the functionality of the node 600 described herein can be incorporated into any of the origins 530.

The metadata 612 associated with any given object 612 indicates, in the various examples shown, an encoder 520 used to encode the corresponding object 610, an origin 530 that stores and distributes the object 610 to CDN 560, a region where that origin 530 resides, a status code associated with the corresponding object 610, and a segment index associated with the object 610. The metadata 612 associated with any given object 610 can include any technically feasible attribute of the object 610. The exemplary attributes shown here are provided for illustrative purposes only, without limitation.

Each invalidation instruction 630 indicates one or more attributes that, if associated with a given cached object 610, indicate that the object is flawed and should be marked invalid. Upon receipt of an invalidation instruction 630, request handler 620 need not invalidate any objects 610 immediately. Instead, request handler 620 may wait until a request for an object is received from an endpoint device 115, and then determine whether the object is invalid based on any previously received invalidation instructions 630. In this manner, request handler 620 can avoid analyzing all cached objects 610 in order to perform cache invalidations.

In a first example shown in FIG. 6, without limitation, invalidation instruction 630-0 indicates that any cached objects 610 derived from encoder 1 and having segment indices 50-200 or 400 onwards are flawed and should be considered invalid. If request handler 620 receives a request for object 610-0, request handler would analyze metadata 612-0 and then determine that object 610-0 is, in fact, derived from encoder 1 and, additionally, has segment index 100, which falls in the index range specified in invalidation instruction 630-0. Therefore, object 610-0 is flawed and should be considered invalid. Request handler 620 may then discard object 610-0 or mark object 610-0 as invalid, and then obtain an alternate, valid version of object 610-0 from another node or origin 530. Objects 610-1 and 610-2 are unaffected by invalidation instruction 630-0.

In a second example shown in FIG. 6, without limitation, invalidation instruction 630-1 indicates that any cached objects 610 derived from origin 022.us-west and having segment indices 100-200 are flawed and should be considered invalid. If request handler 620 receives a request for object 610-1, request handler would analyze metadata 612-1 and then determine that object 610-1 is, in fact, derived from origin 022.us-west and has segment index 150, which falls in the index range specified in invalidation instruction 630-1. Therefore, object 610-1 is flawed and should be considered invalid. Request handler 620 may then discard object 610-1 or mark object 610-1 as invalid, and then obtain an alternate, valid version of object 610-1 from another node or origin 530. Objects 610-0 and 610-2 are unaffected by invalidation instruction 630-1.

In a third example shown in FIG. 6, without limitation, invalidation instruction 630-2 indicates that any cached objects 610 derived from any origin 530 in the us-east region and having HTTP status code 410 are flawed and should be considered invalid. If request handler 620 receives a request for object 610-2, request handler would analyze metadata 612-2 and then determine that object 610-2 is, in fact, derived from an origin 530 that resides in the us-east region and also has an HTTP status code of 410. Therefore, object 610-2 is flawed and should be considered invalid. Request handler 620 may then discard object 610-2 or mark object 610-2 as invalid, and then obtain an alternate, valid version of object 610-2 from another node or origin 530. Objects 610-1 and 610-2 are unaffected by invalidation instruction 630-2.

Referring generally to the various examples described in conjunction with FIG. 6, the disclosed techniques provide a more flexible and granular approach to invalidating cached objects 610 compared to conventional techniques that implement URL matching and/or wildcard pattern matching. In particular, the disclosed techniques allow cached objects 610 stored by origin 530 and/or CDN 560 to be invalidated based on a wide range of possible attributes and based on multiple different attributes. This approach provides an expanded capacity to invalidate cached objects compared to conventional techniques that perform invalidations using URLs.

The invalidation instructions 630 described above may relate to objects associated with a media title currently being streamed by endpoint devices 115, and that media title may be previously recorded or correspond to a live event occurring in real time. Because request handler 620 invalidates objects 610 in response to requests for those objects, in various embodiments, request handler 620 may not need to analyze every cached object 610 each time an invalidation instruction is received. Accordingly, invalidations can be processed with a reduced computational footprint and significantly faster than possible with conventional approaches to invalidation. Further, implementing the request handler 620 within both the origin(s) 530 and the CDN 560 provides an end-to-end solution that allows valid audiovisual content to traverse the network infrastructure 500 while preventing flawed or invalid audiovisual content from traversing the network infrastructure 500.

In some situations, multiple nodes 600 can receive similar invalidation instructions 630 that potentially target a similar set of cached objects 610. For example, and without limitation, a downstream node 600 (e.g. node 550) could invalidate a given object 610 and then request an alternate copy of the object 610 from an upstream node 600 (e.g., node 540). However, the upstream node 600, in response to receiving the request, could determine that a cached copy of the object 610 is also invalid. The upstream node 600 would then need to obtain a valid copy of the object 610 from one of the origins 530 in order to fulfill the request received by the downstream node 600. As a general matter, nodes within CDN 560 coordinate the acquisition of objects 610, based on any received invalidation instructions 630, in order to continuously provide valid versions of objects 610 to endpoint devices 115.

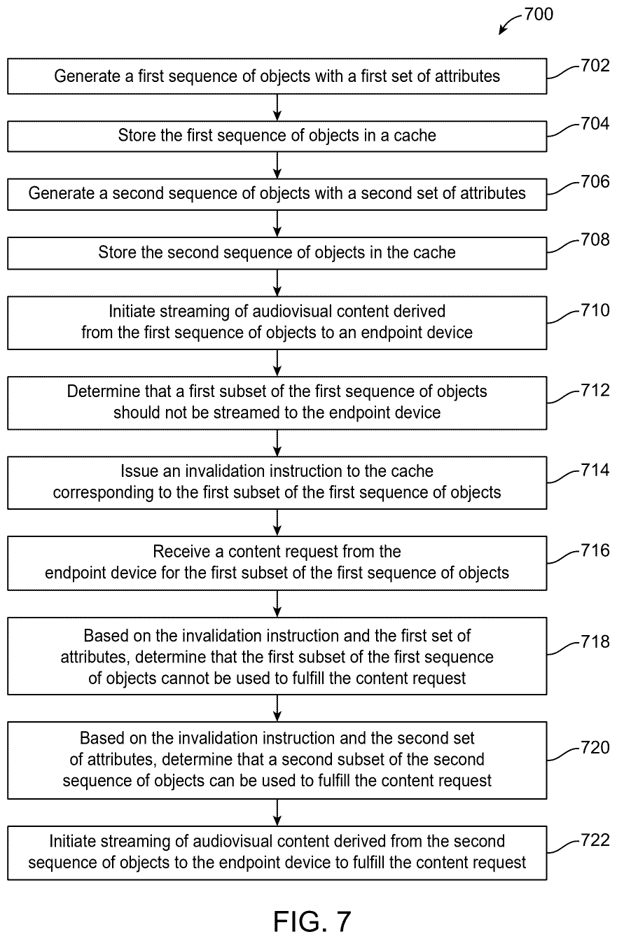

FIG. 7 is a flow diagram of method steps invalidating objects corresponding to one or more segments of audiovisual content that are currently being streamed to an endpoint device, according to various embodiments. Although the method steps are described in conjunction with the systems of FIGS. 1-6, persons skilled in the art will understand that any system configured to perform the method steps, in any order, is within the scope of the present invention.

As shown, a method 700 begins at step 702, where one or more encoders 520 within the network infrastructure 500 generate a first sequence of objects with a first set of attributes. Each object included in the first sequence of objects represents an encoded version of at least one segment associated with a media title. A given object thus includes one or more compressed frames of audiovisual content. Each object may indicate the first set of attributes, or separate metadata may indicate the first set of attributes. Further, each object included in the first sequence of objects can be associated with different attributes. A given attribute could be, for example and without limitation, the encoder 520 used to generate the corresponding object, the origin 530 used to store and distribute the object, a region where that origin 530 resides, a status code associated with the object, or a segment index assigned to the object. At step 704, one or more origins 530 caches the first sequence of objects in CDN 560. CDN 560 can distribute multiple copies of the objects included in the first sequence to any of nodes 540 and/or 550.

At step 706, one or more encoders 520 within the network infrastructure 500 generate a second sequence of objects with a second set of attributes. Similar to the first sequence of objects, each object included in the second sequence of objects represents an encoded version of at least one segment associated with a media title and therefore includes one or more compressed frames of audiovisual content. The first sequence of objects and the second sequence of objects generally correspond to the same portion of a given media title and therefore represent alternate versions of that portion of the given media title. The second set of attributes could indicate, on a per object basis, the encoder 520 used to generate the corresponding object, the origin 530 used to store and distribute the object, a region where that origin 530 resides, a status code associated with the object, or a segment index assigned to the object. At step 708, one or more origins 530 caches the second sequence of objects in CDN 560 across any of nodes 540 and/or 550.

At step 710, an endpoint device 115 initiates streaming of audiovisual content derived from the first sequence of objects. The audiovisual content corresponds to a previously recorded media title or a live event occurring in real time. Upon receipt of a given object, the endpoint device 115 decodes the object to extract the audiovisual content and then outputs one or more frames of the audiovisual content.

At step 712, a control server 120 determines that a first subset of the first sequence of objects should not be streamed to any endpoint devices 115. The first subset includes one or more objects in the sequence of objects. As described above in conjunction with FIG. 5, any of the encoders 520 can be implemented via a control server 130. A given control server 130 can determine that the first subset of the first sequence of objects should not be streamed to endpoint devices 115. In one embodiment, an encoder 520 may determine that the first subset includes encoding artifacts that disrupt video quality. In another embodiment, an encoder 520 may determine that objects included in the first subset are indexed incorrectly and therefore have segment indices that are not synchronized with the segment indices of other sequences of objects. This type of situation can potentially cause frames of audiovisual content to be played back in a manner that diverges from an intended order.

At step 714, the control server 120 issues an invalidation instruction 630 to origins 530 and/or the CDN 560 corresponding to the first subset of the first sequence of objects. The invalidation instruction 630 indicates any technically feasible attribute associated with any object included in the first subset. For example, and without limitation, the invalidation instruction 630 could indicate an encoder 520 used to encode the objects included in the first subset, an origin 530 used to store and distribute the first subset, a region where that origin 530 resides, a status code associated with the objects included in the first subset, or a range of segment indices that includes the segment indices associated with the objects in the first subset. As a general matter, the invalidation instruction includes at least one attribute that can be associated with any given object, and the invalidation instruction applies to and can be used to invalidate any object that includes at least that one attribute. The control server 120 transmits the invalidation instruction 630 to the CDN 560, and the invalidation instruction 630 is then distributed across nodes 540 and 550.

At step 716, a node 540 or 550 receives a request from an endpoint device 115 for the first subset of the first sequence of objects. The objects included in the first subset could correspond, for example and without limitation, to one or more segments of audiovisual content associated with the media title. Upon receipt of a request for any given one or more objects, the node analyzes previously received invalidation instructions 620 to determine whether the requested object(s) should be considered invalid.

At step 718, based on the invalidation instruction and the first set of attributes, the node determines that the first subset of the first sequence of objects cannot be used to fulfill the content request. The node could, for example and without limitation, determine that the objects included in the first subset are derived from an encoder that is indicated in the invalidation instruction and, further, that the requested objects have segment indices that fall within a range of segment indices indicated in the invalidation instruction. As a general matter, invalidation instructions can specify any technically feasible set of attributes, and if a given object has some or all of those attributes, then the object should be considered invalid. Subsequently the node can discard the object(s) or mark the object(s) as invalid. Once the node determines that the first subset of the first sequence of objects is invalid, the node obtains the second subset of the second sequence of objects. The second subset of the second sequence of objects includes one or more objects that represent alternate versions of the objects included in the first subset.

At step 720, based on the invalidation instruction and the second set of attributes, the node determines that the second subset of the second sequence of objects can be used to fulfill the content request. In so doing, the node determines that the one or more objects included in the second subset have attributes that are not associated with the attributes specified in the invalidation instruction and can therefore be considered valid. At step 722, the node initiates streaming of audiovisual content from the second sequence of objects to the endpoint device 115 to service the request. The endpoint device 115, in turn, decodes at least one object included in the second subset and outputs the resultant audiovisual frames. In the manner described, nodes within the CDN 560 can quickly switch to streaming audiovisual content derived from valid objects when other objects are determined to be invalid. In various embodiments, one or more origins 530 may implement steps 716, 718, and 720 to perform passive invalidations. These techniques facilitate the streaming of live events and other types of media titles that should not be subject to delays.

In sum, a content delivery network (CDN) includes a network of nodes configured to store objects representing segments of audiovisual content. Endpoint devices coupled to the CDN are configured to stream audiovisual content to users by requesting objects that represent sequential segments of audiovisual content associated with various media titles. Each node included in the CDN includes a request handler that services requests received from endpoint devices. In response to receiving a given request for a specific object, the request handler first accesses metadata associated with the object. The metadata indicates, among other things, various attributes associated with the object, including an encoder used to encode the object, an origin server that distributes the object, a region where the origin server resides, a status code associated with the object, a time when the object was created and/or modified, and a segment index that reflects a desired ordering with which the audiovisual content associated with the object should be output by an endpoint device. The request handler then accesses a set of invalidation instructions that describe objects which should be invalidated by the node. A given invalidation instruction indicates at least one of the various attributes that can be associated with any given object. The request handler determines, based on the metadata associated with the requested object and based on the set of invalidation instructions, whether any of the invalidation instructions indicate any of the attributes associated with the requested object. If any of the invalidation instructions indicates one or more attributes associated with the object, then the request handler invalidates the object. In doing so, the request handler can mark the object as invalid and/or discard the object entirely. The node can also request an alternate version of the object from another node included in the CDN in order to fulfill the request. If none of the invalidation instructions indicates one or more attributes associated with the object, then the request handler simply fulfills the request using the object.

At least one technical advantage of the disclosed techniques relative to the prior art is that the disclosed techniques enable a CDN to passively invalidate many objects stored in the CDN without having to immediately refresh or reload those objects. Accordingly, with the disclosed techniques, objects can be invalidated using substantially fewer computational resources and incurring significantly less computational cost compared to prior art techniques. Another technical advantage of the disclosed techniques is that, because the URLs associated with every object stored in the CDN do not need to be analyzed when invalidating an object, objects can be invalidated substantially faster compared to prior art techniques. Accordingly, the disclosed techniques are particularly compatible with live streaming implementations, given that live streaming requires valid portions of audiovisual content to be delivered to endpoint devices in a time-sensitive manner. These technical advantages provide one or more technological advancements over prior art approaches.

1. Various embodiments include a computer-implemented method for invalidating cached content stored within a content delivery network, the method comprising receiving an invalidation instruction from a control server, wherein the invalidation instruction includes at least one attribute, receiving a first request for a first object stored in the content delivery network, wherein the first object is associated with a first set of attributes, determining that the first set of attributes includes the at least one attribute, and removing the first object from the content delivery network.

2. The computer-implemented method of clause 1, further comprising transmitting a second request for a second object to a node included in the content delivery network, receiving the second object in response to the second request, and transmitting the second object to an endpoint device to fulfill the first request, wherein the second object comprises an alternate version of the first object, and wherein the second object is associated with a second set of attributes that does not include the at least one attribute.

3. The computer-implemented method of any of clauses 1-2, wherein the at least one attribute indicates a first encoder that was used to encode one or more frames of audiovisual content associated with the first object, and wherein the first set of attributes also indicates the first encoder.

4. The computer-implemented method of any of clauses 1-3, wherein the at least one attribute indicates a first origin server that was used to distribute the first object to the content delivery network, and wherein the first set of attributes also indicates the first origin server.

5. The computer-implemented method of any of clauses 1-4, wherein the at least one attribute indicates a first geographical region associated with a first origin server that was used to distribute the first object to the content delivery network, and wherein the first set of attributes also indicates the first geographical region.

6. The computer-implemented method of any of clauses 1-5, wherein the at least one attribute indicates a hypertext transfer protocol status code associated with the first object, and wherein the first set of attributes also indicates the first status code.

7. The computer-implemented method of any of clauses 1-6, wherein the at least one attribute indicates a first segment index that corresponds to a playback position associated with one or more frames of audiovisual content associated with the first object, and wherein the first set of attributes also indicates the first segment index.

8. The computer-implemented method of any of clauses 1-7, wherein the first object includes one or more frames of compressed audiovisual content associated with a previously recorded media title.

9. The computer-implemented method of any of clauses 1-8, wherein the first object includes one or more frames of compressed audiovisual content associated with a live streaming event.

10. The computer-implemented method of any of clauses 1-9, wherein the content delivery network includes a hierarchy of nodes that stores one or more alternate versions of the first object.

11. The computer-implemented method of any of clauses 1-10, further comprising receiving, at an origin server, the invalidation instruction from the control server, receiving, at the origin server, a second request for a second object stored by the origin server, wherein the second object is also associated with the first set of attributes, determining, at the origin server, that the first set of attributes includes the at least one attribute, and excluding the first object from distribution to the content delivery network.

12. Various embodiments include one or more non-transitory computer-readable media including instructions that, when executed by one or more processors, cause the one or more processors to invalidate cached content stored within a content delivery network by performing the steps of receiving an invalidation instruction from a control server, wherein the invalidation instruction includes at least one attribute, receiving a first request for a first object stored in the content delivery network, wherein the first object is associated with a first set of attributes, determining that the first set of attributes includes the at least one attribute, and removing the first object from the content delivery network.

13. The one or more non-transitory computer-readable media of clause 12, further comprising the steps of transmitting a second request for a second object to a node included in the content delivery network, receiving the second object in response to the second request, and transmitting the second object to an endpoint device to fulfill the first request, wherein the second object comprises an alternate version of the first object, and wherein the second object is associated with a second set of attributes that does not include the at least one attribute.

14. The one or more non-transitory computer-readable media of any of clauses 12-13, wherein the at least one attribute indicates a first encoder that was used to encode one or more frames of audiovisual content associated with the first object, and wherein the first set of attributes also indicates the first encoder.

15. The one or more non-transitory computer-readable media of any of clauses 12-14, wherein the at least one attribute indicates a first geographical region associated with a first origin server that was used to distribute the first object to the content delivery network, and wherein the first set of attributes also indicates the first geographical region.

16. The one or more non-transitory computer-readable media of any of clauses 12-15, wherein the at least one attribute indicates a hypertext transfer protocol status code associated with the first object, and wherein the first set of attributes also indicates the first status code.

17. The one or more non-transitory computer-readable media of any of clauses 12-16, wherein the at least one attribute indicates a first segment index that corresponds to a playback position associated with one or more frames of audiovisual content associated with the first object, and wherein the first set of attributes also indicates the first segment index.

18. The one or more non-transitory computer-readable media of any of clauses 12-17, further comprising the steps of generating, via a first encoding pipeline, a first set of objects that includes the first object, generating, via a second encoding pipeline, a second set of objects that includes a second object, wherein the second object comprises an alternate version of the first object, and transmitting the second object to an endpoint device to fulfill the first request subsequent to removing the first object from the content delivery network.

19. The one or more non-transitory computer-readable media of any of clauses 12-18, wherein the first set of attributes is included in the first object.

20. The one or more non-transitory computer-readable media of any of clauses 12-19, wherein the first set of attributes is included in hypertext transfer protocol header associated with the first object.

21. Various embodiments include a system comprising one or more memories storing instructions, and one or more processors coupled to the one or more memories that, when executing the instructions, perform the steps of receiving an invalidation instruction from a control server, wherein the invalidation instruction includes at least one attribute, receiving a first request for a first object stored in the content delivery network, wherein the first object is associated with a first set of attributes, determining that the first set of attributes includes the at least one attribute, and removing the first object from the content delivery network.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for invalidating cached content stored within a content delivery network, the method comprising:
receiving an invalidation instruction from a control server, wherein the invalidation instruction includes at least one attribute;
receiving a first request for a first object stored in the content delivery network, wherein the first object is associated with a first set of attributes;
determining that the first set of attributes includes the at least one attribute; and
removing the first object from the content delivery network.

2. The computer-implemented method of claim 1, further comprising:
transmitting a second request for a second object to a node included in the content delivery network;
receiving the second object in response to the second request; and
transmitting the second object to an endpoint device to fulfill the first request, wherein the second object comprises an alternate version of the first object, and wherein the second object is associated with a second set of attributes that does not include the at least one attribute.

3. The computer-implemented method of claim 1, wherein the at least one attribute indicates a first encoder that was used to encode one or more frames of audiovisual content associated with the first object, and wherein the first set of attributes also indicates the first encoder.

4. The computer-implemented method of claim 1, wherein the at least one attribute indicates a first origin server that was used to distribute the first object to the content delivery network, and wherein the first set of attributes also indicates the first origin server.

5. The computer-implemented method of claim 1, wherein the at least one attribute indicates a first geographical region associated with a first origin server that was used to distribute the first object to the content delivery network, and wherein the first set of attributes also indicates the first geographical region.

6. The computer-implemented method of claim 1, wherein the at least one attribute indicates a hypertext transfer protocol status code associated with the first object, and wherein the first set of attributes also indicates the first status code.

7. The computer-implemented method of claim 1, wherein the at least one attribute indicates a first segment index that corresponds to a playback position associated with one or more frames of audiovisual content associated with the first object, and wherein the first set of attributes also indicates the first segment index.

8. The computer-implemented method of claim 1, wherein the first object includes one or more frames of compressed audiovisual content associated with a previously recorded media title.

9. The computer-implemented method of claim 1, wherein the first object includes one or more frames of compressed audiovisual content associated with a live streaming event.

10. The computer-implemented method of claim 1, wherein the content delivery network includes a hierarchy of nodes that stores one or more alternate versions of the first object.

11. The computer-implemented method of claim 1, further comprising:
receiving, at an origin server, the invalidation instruction from the control server;
receiving, at the origin server, a second request for a second object stored by the origin server, wherein the second object is also associated with the first set of attributes;
determining, at the origin server, that the first set of attributes includes the at least one attribute; and
excluding the first object from distribution to the content delivery network.

12. One or more non-transitory computer-readable media including instructions that, when executed by one or more processors, cause the one or more processors to invalidate cached content stored within a content delivery network by performing the steps of:
receiving an invalidation instruction from a control server, wherein the invalidation instruction includes at least one attribute;
receiving a first request for a first object stored in the content delivery network, wherein the first object is associated with a first set of attributes;
determining that the first set of attributes includes the at least one attribute; and
removing the first object from the content delivery network.

13. The one or more non-transitory computer-readable media of claim 12, further comprising the steps of:
transmitting a second request for a second object to a node included in the content delivery network;
receiving the second object in response to the second request; and
transmitting the second object to an endpoint device to fulfill the first request, wherein the second object comprises an alternate version of the first object, and wherein the second object is associated with a second set of attributes that does not include the at least one attribute.

14. The one or more non-transitory computer-readable media of claim 12, wherein the at least one attribute indicates a first encoder that was used to encode one or more frames of audiovisual content associated with the first object, and wherein the first set of attributes also indicates the first encoder.

15. The one or more non-transitory computer-readable media of claim 12, wherein the at least one attribute indicates a first geographical region associated with a first origin server that was used to distribute the first object to the content delivery network, and wherein the first set of attributes also indicates the first geographical region.

16. The one or more non-transitory computer-readable media of claim 12, wherein the at least one attribute indicates a hypertext transfer protocol status code associated with the first object, and wherein the first set of attributes also indicates the first status code.

17. The one or more non-transitory computer-readable media of claim 12, wherein the at least one attribute indicates a first segment index that corresponds to a playback position associated with one or more frames of audiovisual content associated with the first object, and wherein the first set of attributes also indicates the first segment index.

18. The one or more non-transitory computer-readable media of claim 12, further comprising the steps of:
generating, via a first encoding pipeline, a first set of objects that includes the first object;
generating, via a second encoding pipeline, a second set of objects that includes a second object, wherein the second object comprises an alternate version of the first object; and
transmitting the second object to an endpoint device to fulfill the first request subsequent to removing the first object from the content delivery network.

19. The one or more non-transitory computer-readable media of claim 12, wherein the first set of attributes is included in the first object.

20. The one or more non-transitory computer-readable media of claim 12, wherein the first set of attributes is included in hypertext transfer protocol header associated with the first object.

21. A system comprising:
one or more memories storing instructions; and
one or more processors coupled to the one or more memories that, when executing the instructions, perform the steps of:
receiving an invalidation instruction from a control server, wherein the invalidation instruction includes at least one attribute,
receiving a first request for a first object stored in the content delivery network, wherein the first object is associated with a first set of attributes,
determining that the first set of attributes includes the at least one attribute, and
removing the first object from the content delivery network.
